(19) United States
(12) Patent Application Publication
(10) Pub. No.: US 2002/0191231 A1
(43) Pub. Date: Dec. 19, 2002

(54) Transparent scanning light source for scanner

(76) Inventors: Yin-Chun Huang, Hsinchu (TW); Chih-Wen Huang, Hsinchu (TW)

Correspondence Address: J.C. Patents, Inc., Suite 114, 1340 Reynolds Ave., Irvine, CA, 92614, US

(21) Appl. No.: 09/882,211

(22) Filed: Jun. 15, 2001

(51) Int. Cl. H04N 1/46

(52) U.S. Cl. 358/506

(57) ABSTRACT

A transparent scanning light source for a scanner. The transparent scanning light source, having both lamps and their associated transformer, is mounted on a base frame and an n-shape light-channeling board is mounted on a cover. By detaching the light-channeling board and the lamps, fabrication of the cover is simplified. The light-channeling board is divided into an illumination section, a support section on each side of the illumination section and a corner section at the junction between the illumination section and the support section. The bottom surface of the support section is capable of channeling light emitted from the lamp into the light-channeling board and out through an irradiation area underneath the illumination section. A diffuser plate is also attached to the irradiation area of the illumination section so that an evenly spread light source is produced for transparent scanning.

### BACKGROUND OF THE INVENTION

1. Field of Invention

The present invention relates to a light source design for a scanner. More particularly, the present invention relates to a scanner having a transparent scanning light source comprising a light-channeling board and a light source mounted separately on the cover and the base frame of the scanner.

2. Description of Related Art

A scanner is a type of scanning tool that combines the attributes of a photocopier and a camera. In their early stage, scanners were expensive and unpopular. However, due to many technological breakthroughs in the computer industry, the price of scanners has dropped considerably, leading to widespread use. Nowadays, most image scanners incorporate optical word recognition software and a simple storage facility so that a user may copy an entire document or any portion thereof. In general, a scanner can scan a document in a reflection mode and a transparent mode. In the reflection mode, the light source must be on the same side as the scanning device (relative to the scanning document). In contrast, the transparent mode demands that the light source and the scanning device be on opposite sides (relative to the scanning document). At present, most image scanners are capable of scanning in both the reflective and the transparent mode. In other words, manufacturers must include a light source for performing reflective scanning and another light source for performing transparent scanning in the design of a scanner.

To carry out transparent scanning using a conventional scanner, a transparent scanning light source must be provided. The transparent scanning light source is usually installed in the cover above the base frame of a scanner. FIGS. 1A and 1B are sketches showing a conventional transparent scanning light source in the cover of a scanner. The transparent scanning light source mainly includes a light-channeling board 102, a pair of lamps 104, a transformer 106 and a diffuser plate 108. The light-channeling board 102, the lamps 104 and the transformer 106 are positioned at suitable locations on a transparent cover (TC). The lamp 104 is electrically connected to the transformer 106 for emitting light. The lamps 104 are positioned on each side of the light-channeling board 102 so that light emitted from each lamp 104 is channeled to the light-channeling board 102. Finally, light passing to the light-channeling board 102 is homogenized after passing through the diffuser plate 108 to facilitate transparent scanning.

In brief, the transparent scanning light source of a conventional scanner includes at least three major components: a pair of lamps, a transformer and a light-channeling board. Since all three components must be installed in the cover of the scanner, cover design of a conventional scanner is particularly complicated, leading to a high cost for producing the transparent scanning light source.

### SUMMARY OF THE INVENTION

Accordingly, one object of the present invention is to provide a scanner with a transparent scanning light source that includes of a pair of lamps, a transformer and a light-channeling board. The lamp and transformer portion of the light source is mounted on a base frame while the light-channeling board portion is mounted on a cover so that design is simplified and production cost of the transparent scanning light source is reduced.

A second object of this invention is to provide a scanner having a transparent scanning light source whose light-channeling board has an n-shaped profile. A light-reflecting structure such as a triangular prism or a reflecting mirror may be installed at the corner region of the light-channeling board so that light from a pair of lamps may be re-directed towards the irradiation surface of the light-channeling board.

To achieve these and other advantages and in accordance with the purpose of the invention, as embodied and broadly described herein, the invention provides a scanner having a transparent scanning light source that comprises a pair of lamps, a transformer and an n-shaped light-channeling board. The lamps and transformer system are mounted on the base frame of the scanner and the n-shaped light-channeling board is mounted on the cover of the scanner. By separating the light-channeling board and the lamps, manufacturing the cover of a scanner is very much simplified. The n-shaped light-channeling board includes an illumination section, a support section on each side of the illumination section and a corner section at the intersection between the illumination section and the support section. The bottom surface of the support section has the capacity to receive light emitted from a lamp. Light transmitted through the bottom surface of the support section passes through the corner section before arriving at the illumination section. Light from the illumination section is forwarded to a diffuser plate via an irradiation surface underneath the illumination section. After passing through the diffuser plate, the light can serve as a light source for conducting a transparent scanning. Furthermore, to increase light channeling capacity and reduce light attenuation through the light-channeling board, reflecting plates having identical area as the light-channeling board or light reflecting structures such as triangular prisms or light-reflecting mirrors may be added to corner section of the light-channeling board. Because the lamp and the transformer are installed on the base frame of the scanner instead of the cover, electromagnetic interference caused by electrical current going to the cover is avoided.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A and 1B are sketches showing a conventional transparent scanning light source in the cover of a scanner;

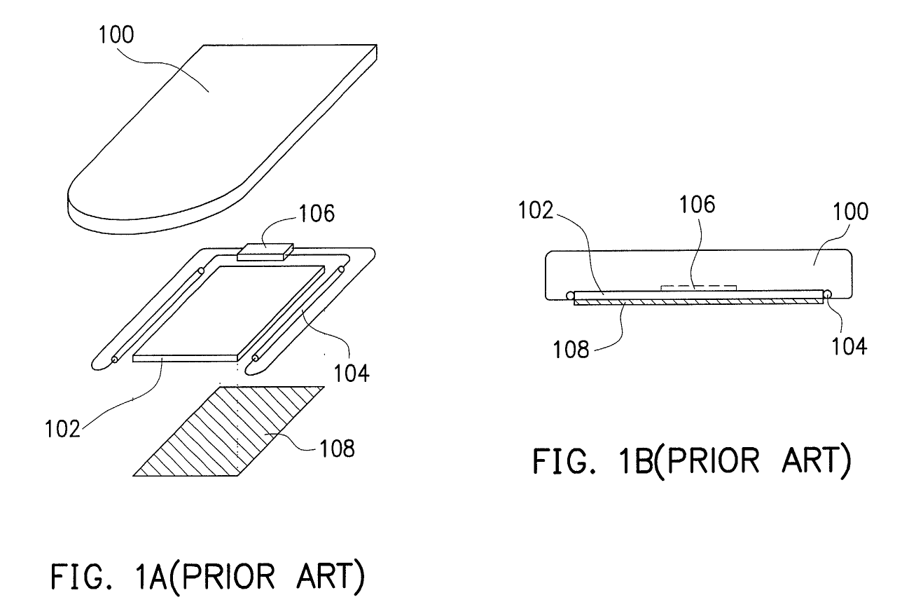

FIGS. 2A and 2B are sketches showing a light-channeling board, a diffuser plate and a light-reflecting plate according to one preferred embodiment of this invention;

FIGS. 3A and 3B are sketches showing a transparent scanning light source of a scanner according to one preferred embodiment of this invention;

FIGS. 4A to 4C are a series of diagrams showing the screw-latching structures on the backside of the light-channeling board and the cover for assembling the two together according to this invention;

FIG. 5 is a schematic cross-sectional view of the light-channeling board according to this invention; and

FIG. 6 is a perspective view showing a pair of contact triggering switches on the upper surface of the base frame and the cover for controlling and testing the transparent scanning light source according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

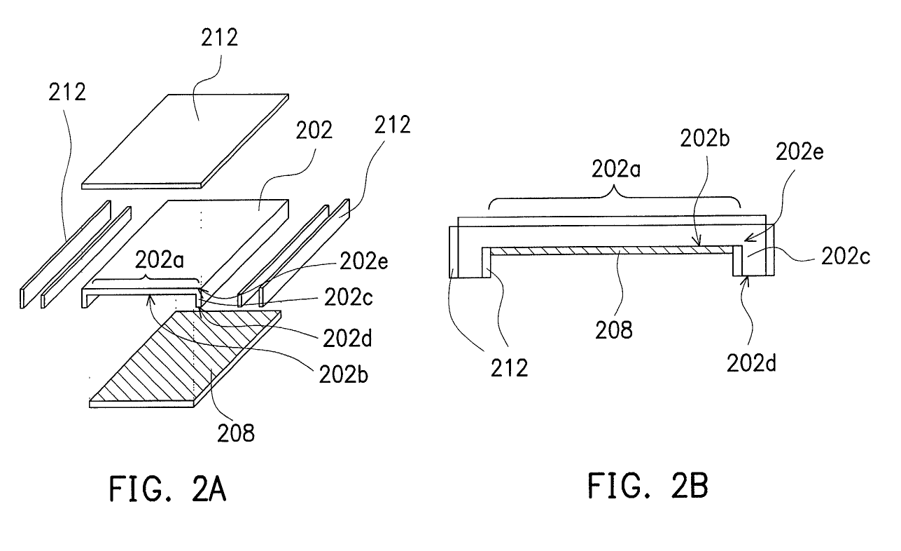

FIGS. 2A and 2B are sketches showing a light-channeling board, a diffuser plate and a light-reflecting plate according to one preferred embodiment of this invention. As shown in FIGS. 2A and 2B, the light-channeling board 202 has an n-shaped cross-section, for example. According to function, the n-shaped light-channeling board 202 can be divided into an illumination section 202a, a pair of support sections 202c, one on each side of the illumination section 202a, and a corner section 202e at the junction between the illumination section 202a and the support section 202c. The bottom surface 202d of each support section 202c is capable of receiving light from a lamp. Light that passes through the bottom surface 202d of the support sections 202c is transmitted to the illumination section 202a via the corner sections 202e. Finally, light beams out from an irradiation surface 202b underneath the illumination section 202a. The light beamed out from the irradiation surface 202b is suitable for performing a transparent scanning. To increase the channeling capacity of the light-channeling board 202, for example, a plurality of reflective plates 212 having an area identical to various surfaces of the light-channeling board 202 may be attached to the surfaces. The reflective plates prevent any diversion of light away from the light-channeling board, which would lead to light attenuation. In addition, a diffuser plate 208 may be attached to the irradiation surface 202b. The diffuser plate 208 has the capacity to homogenize light coming out from the irradiation surface 202b so that a uniform and smooth light source is produced for any transparent scanning.

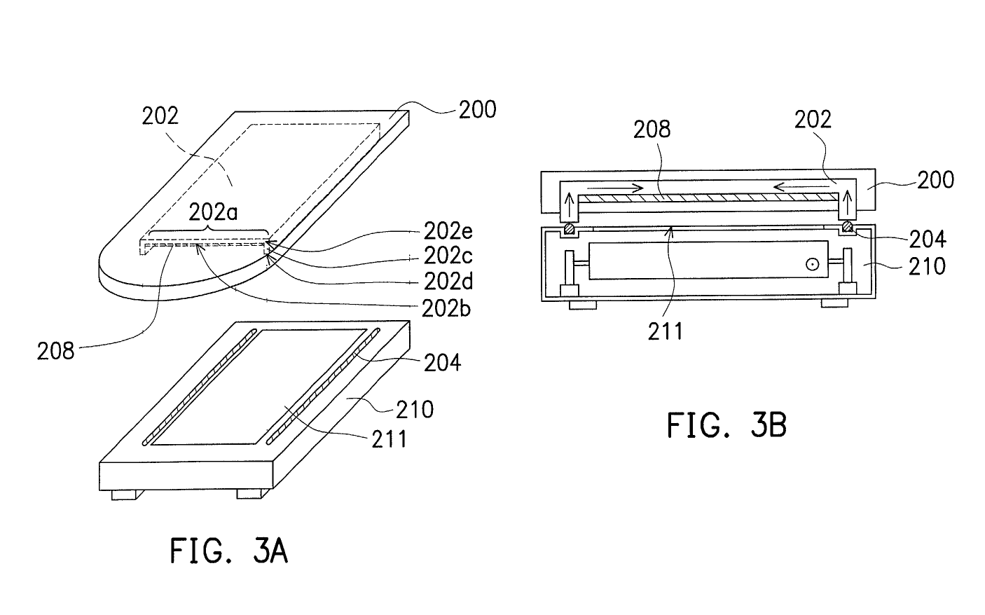

FIGS. 3A and 3B are sketches showing a transparent scanning light source of a scanner according to one preferred embodiment of this invention. As shown in FIGS. 3A and 3B, the pair of lamps 204 and a transformer (not shown) are mounted on a base frame 210. The aforementioned light-channeling board 202 is mounted on a cover 20. With this arrangement, design of the transparent scanning light source is simplified. In addition, since the lamps 204 and the transformer are not part of the cover, the cover does not need a power source. Moreover, the problem of electromagnetic interference (EMI) is entirely avoided.

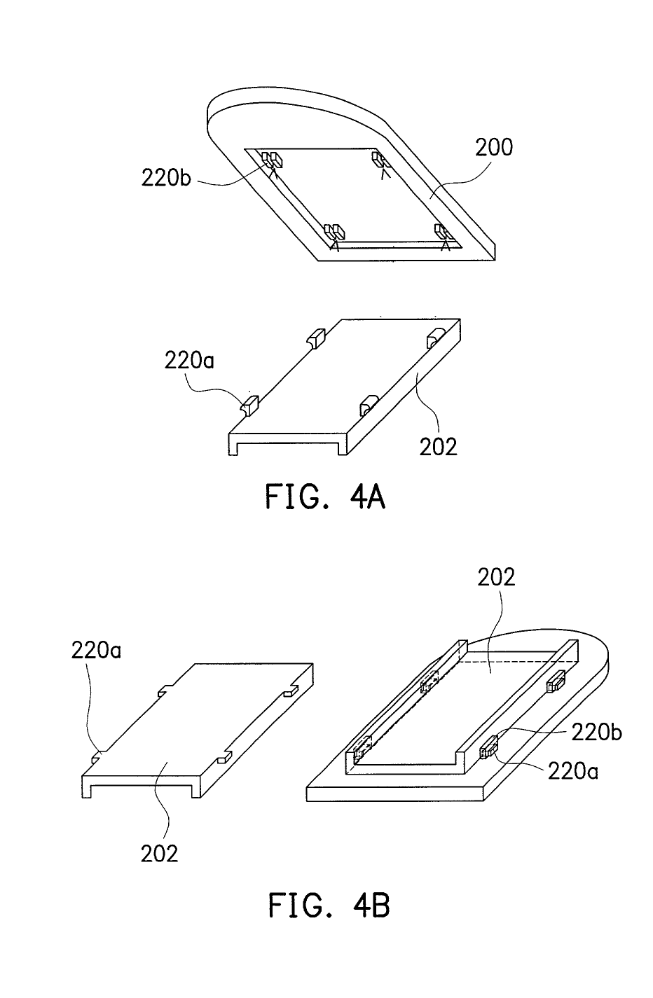

The following description relates to the cover of an image scanner. First, a cover for an image scanner is provided. A light-channeling board 202 is mounted on the cover 200. The light-channeling board 202, for example, has an n-shaped cross-section. According to function and position, the light-channeling board 202 can be further divided into an illumination section 202a, a pair of support sections 202c and a pair of corner sections. One support section is located on each side of the illumination section 202a. One corner section is located at the junction between the illumination section 202a and the support sections. The light-channeling board 202 is attached to the cover 200 by latching, taping or screw fastening (shown in FIGS. 4A to 4C), for example. The latching, taping, or screw fastening mechanism on backside of the light-channeling board 202 and the interior walls of the cover 200 may be formed as a single piece by injection molding. Thus, there is no limitation due to the degree of structural complexity.

The following description relates to the cover of an image scanner. Two or more lamps 204 and their corresponding or common transformer (not shown) are mounted on the upper surface of a base frame 210. The lamps are positioned near the edges of a scanning region 211. The lamps, for example, have a linear tubular structure. In addition, the lamps 204 on the upper surface of the base frame 210 correspond in position to the bottom end 202d of the support section 202c. Hence, light from the lamps 204 is able to reach the irradiation surface 202b of the light-channeling board 202 via the bottom end 202d, the support section 202c and the corner section 202e. Light emitted from the irradiation surface 202 passes through a diffuser plate 208 so that a homogeneous light source for conducting transparent scanning is produced.

FIGS. 4A to 4C are a series of diagrams showing the screw-latching structures on the backside of the light-channeling board and the cover for assembling the two together according to this invention. First, as shown in FIGS. 4A and 4B, the light-channeling board 202 is mounted on the cover 200 by latching. For example, the backside of the light-channeling board 202 has a latching structure 220a and the cover 200 also has a corresponding set of latching structures 220b. By clicking the latching structures 220a and the latching structures 220b together, the light-channeling board 202 is mounted onto the cover 200.

In FIG. 4C, the light-channeling board 202 is mounted on the cover 200 by latching and a fastening screw. The backside of the light-channeling board 202 has latching structures 220a on one side and a screw fastening structure 222 on the other side. Similarly, the cover has a corresponding latching structure 220b on one side. Utilizing the matching latch structures 220 and 220b and putting a screw into the screw fastening structure 222, the light-channeling board is fastened tightly to the cover 200.

The aforementioned latching structures 220a and the light-channeling board 202 may be formed by injection molding as one piece. Likewise, latching structure 220b and the screw fastening structure 222 may be formed with the cover 200 by injection molding as one piece. Therefore, once a model for forming the cover 200 and the light-channeling board 202 is produced, the cover 200 and the light-channeling board 202 can be mass-produced.

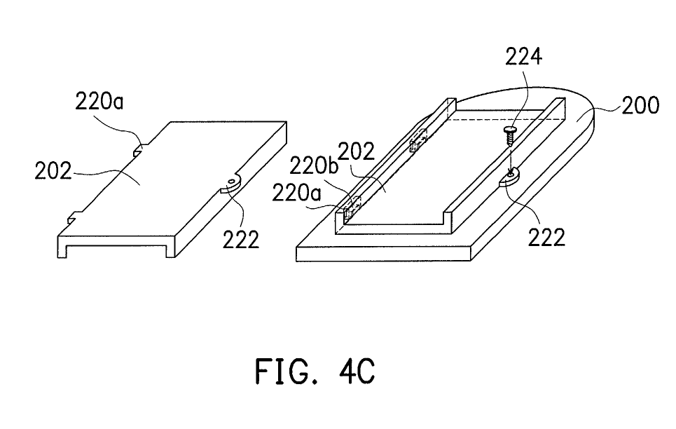

FIG. 5 is a schematic cross-sectional view of the light-channeling board according to this invention. To increase light-channeling capacity of the light-channeling board 202, a set of reflective plates 212, identical in size, is attached to various outer surfaces of the light-channeling board 202. The reflective plates reflect any possible stray light back into the board 202, thereby reducing light attenuation. In addition, a light-reflecting structure 214 such as a reflecting mirror or a triangular prism may also be position at the corner sections 202e of the light-channeling board 202. Incoming light moving through the bottom end 202d of the support section in direction 216 is reflected into the illumination section 202a by the light-reflecting structure 214 at the corner sections 202e. Hence, the light-reflection structure 214 further reduces light attenuation inside the light-channeling board 202.

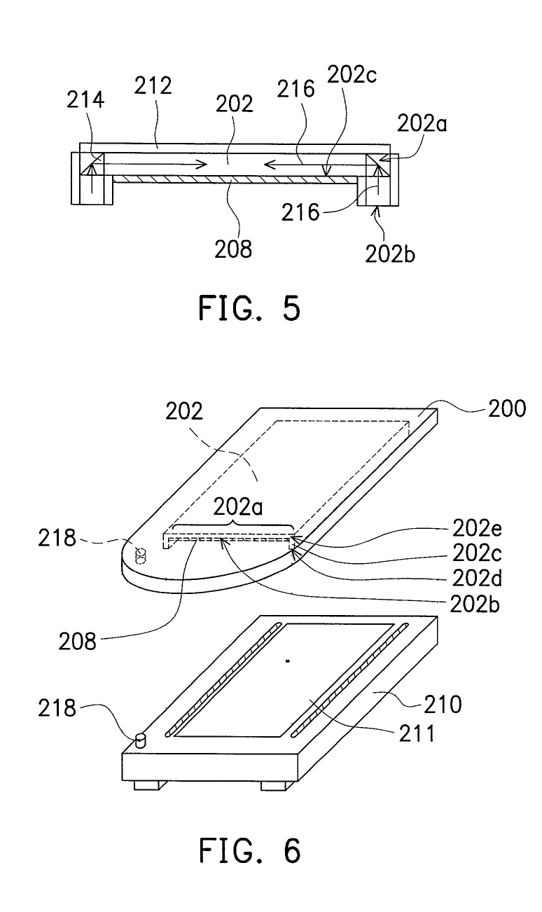

FIG. 6 is a perspective view showing a pair of contact triggering switches on the upper surface of the base frame and the cover for controlling and testing the transparent scanning light source according to one preferred embodiment of this invention. As shown in FIG. 6, the triggering switch 218 is positioned at one corner on the upper surface of the base frame 210. When the cover 200 is lowered onto the base frame 210, the triggering switch 218 is activated so that the lamp 204 is turned on. Hence, the system can automatically monitor the function of the transparent scanning light source.

In this invention, the transparent scanning light source can be applied to a scanning system having both transparent scanning and reflective scanning modes through software switching. In addition, this invention can also be used purely for transparent scanning.

In conclusion, principal advantages of the transparent scanning light source according to this invention include:

1. By mounting the light-channeling board on the cover and the lamps and transformer on the base frame, cover design is simplified.

2. Because the lamps and the transformer are on the base frame, a power circuit in the cover is unnecessary. Since there is no power circuit in the cover, electromagnetic interference (EMI) problems can be avoided.

3. The light-channeling board of this invention has an n-shaped cross-section and the attached reflective plates can concentrate light within the board medium into the irradiation surface. Hence, more effective transparent scanning is conducted.

4. The n-shaped light-channel board also has a reflecting mirror or triangular prism at the corner section (the end of the support section) so that light is more effectively channeled towards the irradiation surface for transparent scanning.

5. A triggering switch is also installed at the upper surface of the base frame so that control and testing of the transparent scanning light source can be activated when contact is made with the cover.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transparent scanning light source for a scanner, wherein the scanner has a base frame and a cover and an upper surface of the base frame has a scanning region, the transparent scanning light source comprising:
a plurality of lamps, wherein the lamps are positioned outside the scanning region on the base frame;
a light-channeling board mounted on the cover, wherein the light-channeling board includes an illumination section and a support section on each side of the illumination section, a bottom surface of the support section corresponds in position to the lamp so that light emitted from the lamp can pass through the bottom surface into the support section, and underneath the illumination section is an irradiation surface that corresponds in position to the scanning region.; and
a diffuser plate attached to the irradiation surface.

2. The transparent scanning light source of claim 1, wherein the lamps include a pair of parallel tubular lamps and a transformer associated with the parallel tubular lamps.

3. The transparent scanning light source of claim 1, wherein the light-channeling board has an n-shaped cross-section.

4. The transparent scanning light source of claim 1, wherein the illumination section and the support sections of the light-channel board are formed by injection molding.

5. The transparent scanning light source of claim 1, wherein the light source further includes a plurality of reflective plates attached to exterior surfaces of the illumination section and the support sections of the light-channeling board.

6. The transparent scanning light source of claim 1, wherein the light-channeling board is mounted on the cover through a plurality of fastening structures, and the fastening structures between the light-channel board and the cover include latches, tape and screws.

7. The transparent scanning light source of claim 6, wherein the fastening structure on the light-channeling board and the light-channeling board itself are formed together as a single piece by injection molding.

8. The transparent scanning light source of claim 1, wherein the base frame surface further includes a triggering switch that activates and monitors the transparent scanning light source when the cover is lowered.

9. A transparent scanning light source for a scanner, wherein the scanner has a base frame and a cover and an upper surface of the base frame has a scanning region, the transparent scanning light source comprising:
a plurality of lamps, wherein the lamps are positioned on the base frame outside the scanning region;
a light-channeling board mounted on the cover, wherein the light-channeling board includes an illumination section and a support section on each side of the illumination section, the support sections prop up the illumination section of the light-channeling board over the scanning region, a bottom surface of the support section corresponds in position to the lamp so that light emitted from the lamp can pass through the bottom surface into the support section, an upper end of the support section has a light-reflecting structure and underneath the illumination section is an irradiation surface that corresponds in position to the scanning region; and
a diffuser plate attached to the irradiation surface.

10. The transparent scanning light source of claim 9, wherein the lamps include a pair of parallel tubular lamps and their associated transformer.

11. The transparent scanning light source of claim 9, wherein the light-channeling board has an n-shaped cross-section.

12. The transparent scanning light source of claim 9, wherein the illumination section and the support sections of the light-channel board are formed by injection molding.

13. The transparent scanning light source of claim 9, wherein the light-reflecting structure includes a reflecting mirror or a triangular prism.

14. The transparent scanning light source of claim 9, wherein the light source further includes a plurality of reflective plates attached to exterior surfaces of the illumination section and the support sections of the light-channeling board.

15. The transparent scanning light source of claim 9, wherein the light-channeling board is mounted on the cover through a plurality of fastening structures, and the fastening structures between the light-channel board and the cover include latches, tape and screws.

16. The transparent scanning light source of claim 15, wherein the fastening structure on the light-channeling board and the light-channeling board itself are formed together as a single piece by injection molding.

17. The transparent scanning light source of claim 9, wherein the base frame surface further includes a triggering switch that activates and monitors the transparent scanning light source when the cover is lowered.
